(19) United States
(12) Patent Application Publication
(10) Pub. No.: US 2013/0276357 A1
(43) Pub. Date: Oct. 24, 2013

(54) COMBATING INSECT INFESTATIONS

(71) Applicants: Michael Edward Shannon, Picton (CA); Dick Eric Zoutman, Kingston (CA)

(72) Inventors: Michael Edward Shannon, Picton (CA); Dick Eric Zoutman, Kingston (CA)

(73) Assignee: MEDIZONE INTERNATIONAL INC., Stinson Beach, CA (US)

(21) Appl. No.: 13/821,499

(22) PCT Filed: Sep. 7, 2011
(86) PCT No.: PCT/CA11/50543

§ 371 Date: Mar. 7, 2013

Related U.S. Application Data
(60) Provisional application No. 61/380,763, filed on Sep. 8, 2010.

(51) Int. Cl. A01M 1/20

(52) U.S. Cl. CPC A01M 1/2022
USPC 43/132.1

(57) ABSTRACT

Bed bug infestations are combated by exposure to a disinfecting atmosphere which includes ozone and hydrogen peroxide, at a relative humidity of at least 30%.

### FIELD OF THE INVENTION

This invention relates to insect infestations and methods and systems for combating insect infestations. More particularly, it relates to methods and systems for attacking and destroying infestations of “bed bugs” and similar insect pests, lodged in interior room spaces, upholstery, bedding, draperies, fabrics and other fibrous locations.

BACKGROUND OF THE INVENTION AND PRIOR ART

Bed bugs are parasitic insects of the family Cimicidae. They feed preferentially on human blood and the blood of other warm-blooded animals. They are mainly active at night. They grow to a length of 4-5 mm and a width of 1.5-3 mm. Best adapted to human environments is the common bedbug Cimex lectularius, found in temperate climates throughout the world. Other species include Cimex hemipterus, found in tropical regions, and Leptocimex boueti, in tropical regions of South America and West Africa.

Bites from bed bugs often go undetected at the time, and in many instances there is no visible sign of the bite. However, they cause a skin condition known as cimicosis which is accompanied by serious skin itching which can lead to anxiety, stress and insomnia, as well as secondary infection as a result of scratching. Largely because of their nocturnal habits, bed bugs are hard to detect and eradicate. They are not an easily identifiable problem.

With the advent of the insecticide DDT in the early 1940s, bed bugs were largely eradicated in countries of the developed world. The last twenty years or so have, however, seen a resurgence of bed bug infestations, not only in domestic dwellings but also in theatres, hotels, hospitals, jails, cruise ships, moving vehicles and public transportation. This may be due to increased international travel, use of new pest-control methods that do not affect bed bugs, and increasing pesticide resistance. For example, the number of reported incidents of bed bug infestations in New York City rose from 500 in 2004 to 10,000 in 2009. Because of the social stigma associated with bed bugs, there is probably under-reporting of such incidents.

U.S. Pat. No. 7,404,624 Cumberland et. al., issued Aug. 5, 2008, describes methods for abating allergens, pathogens, odours and volatile organic compounds in air, using an atmosphere having specific combinations of ozone concentration, hydrogen peroxide concentrations, temperature and humidity delivered over a specified period of time. The patent contains an experimental account of treating rooms of a residence, effectively treating cladosporium mold spores and penicillium/aspergillus molds in the room air. No details of the precise conditions used are given. The general disclosure of the patent states that selected conditions of ozone concentration, hydrogen peroxide, humidity and temperature are effective in killing various pathogens, including dust mite allergens, at ozone concentrations below 6-9 ppm, but the precise conditions used are not disclosed. In general, the patent teaches use in an atmosphere of 2-10 ppm ozone, hydrogen peroxide which is 75%-150% by weight of the atmospheric ozone concentration, at a temperature of 15-27° C. and time 0.5-3 hours. Insect infestations are not disclosed as a target for the process described.

It is an object of the present invention to provide a novel and effective method of combating bed bug infestations.

### SUMMARY OF THE INVENTION

The present invention provides, from one aspect, a process of combating bed bugs, eggs or larvae thereof, which comprises exposing bed bugs or their larvae or eggs to a disinfecting atmosphere which includes ozone at a concentration of 2-350 ppm by weight and hydrogen peroxide at an amount of 0.2-10 wt. %, at a relative humidity of at least 30%, and for a period sufficient for an effective kill of the bed bugs. When the process of the invention is conducted in an enclosed space such as a room in a dwelling, the process includes a subsequent step of removing ozone from the atmosphere, down to 0.04 ppm or less.

Another aspect of the invention provides a portable system for destroying bed bugs, eggs or larvae thereof, in rooms and on surfaces therein, comprising an ozone generator for discharging into the room a gaseous mixture including ozone; an ozone controller adapted to control the amount of discharged ozone; a source of hydrogen peroxide for discharging controlled amounts of hydrogen peroxide into the room; means for discharging the hydrogen peroxide and ozone into the room; humidity adjusting means adapted to increase or decrease the relative humidity of the room during treatment; and an ozone remover adapted to destroy ozone, down to a safe level in the room atmosphere for subsequent human utilization.

### BRIEF REFERENCE TO THE DRAWINGS

FIG. 1 of the accompanying drawings is a diagrammatic illustration of an apparatus in accordance with an embodiment of the invention, disposed within a room to be disinfected;

FIGS. 2A and 2B are diagrammatic illustrations of physical agitation systems for use in embodiments of the invention;

FIG. 3 is a diagrammatic illustration of an apparatus according to the invention, in portable, transportation mode;

### THE PREFERRED EMBODIMENTS

Preferred ozone amounts for use in the invention are from about 20-350 parts per million in the disinfection atmosphere, more preferably 20-200, even more preferably 20-90 parts per million in the oxygen/ozone gas mixture, and most preferably 35-80 ppm ozone. Preferred amounts of hydrogen peroxide are the amounts supplied to the disinfecting atmosphere using an aqueous solution containing 0.2-10%, more preferably 1-5%, hydrogen peroxide. In the description below, the peroxide percentages used are sometimes expressed in terms of these solution percentages. The amounts are chosen so that no serious deleterious effects are suffered by other equipment in the treatment room to which the disinfecting atmosphere is supplied. The amount of hydrogen peroxide in the disinfecting atmosphere can be calculated from the volume of aqueous hydrogen peroxide evaporated into the disinfecting atmosphere, the volume of the room being disinfected and the concentration of hydrogen peroxide in the starting solution. Times of exposure of the room and its surface to the disinfecting atmosphere are suitably from 10 minutes to about 120 minutes, preferably from about 30 to about 105 minutes, and most preferably about 60 minutes. These times are constrained to some extent by the need to clear the room of ozone (down to a maximum of 0.04 ppm) following the disinfection phase, and return the room to normal use within a reasonable period of time, with the entire start-to-finish time not exceeding 150 minutes. The ozone removal is an extremely rapid and fully effective process. Both the hydrogen peroxide and the ozone (and any products of interaction between them) should be removed before the room is put back into normal use.

The preferred portable system for destroying bed bugs according to the present invention includes, as part of its means for discharging the hydrogen peroxide and ozone into the room, a dislodgement system at the outlet end of the discharging means. The dislodgement system allows penetration of carpet, drape and similar surfaces in the room, to gain access to concealed/sequestered bed bugs, their eggs and larva. The dislodgement system is preferably manually operated, with operators protected by a hazard suit and mask. It may take the form of one or more outlet jets, with associated manually operable jet pressure controls. It may take the form of a revolving or fixed brush with bristles of appropriate stiffness, alone or in combination with an outlet jet. Any form of dislodgement system effective to disturb the pile of carpet fabrics, upholstery, mattresses, fabrics and the like so as to access the remote parts which might harbor bed bugs, their eggs or larvae can be used. This includes non-physical applications such as air jets, ultrasonic energy radio-frequency energy and electromagnetic waves, for example, capable of causing physical disruption and which result in micro-physical movements of fibrous surfaces. Manual application with pressure, e.g. pressure jets at the outlet, is especially preferred for dealing with colonies of bed bugs and their eggs on soft furnishings. Remote and automatic operation is useful in some circumstances.

The ozone for use in the present invention can be generated by any known means. For use in relatively small spaces such as hotel rooms and cruise ship rooms (typically 250-450 sq. ft.), an ultraviolet generating system for ozone generation is preferred, on account of its lower power requirements. In such a system, air from the room itself may be fed into the ozone generating unit, where it encounters UV radiation of appropriate wavelength. For treating larger rooms and spaces, oxygen may be subjected to corona or other electrical discharge to generate ozone. Then the apparatus of the invention preferably includes a container of medical grade oxygen. The oxygen container can be a standard, pressurized vessel containing medical grade oxygen, of the type commonly found in medical facilities. Oxygen from this container is fed to an ozone generator, where the oxygen is subjected to electrical discharge, normally with high voltage alternating current, to convert small amounts of the oxygen to ozone and produce a gaseous mixture of oxygen and ozone. The quantity of ozone in the mixture is controllable by adjustment of the voltage of the electrical discharge. Suitable ozone generators are known and available commercially. The relative amounts of ozone generated are relatively small, expressed in parts per million (ppm), but such is the power of ozone as a disinfectant, especially in combination with hydrogen peroxide in accordance with this invention, that such small quantities thereof are all that is required.

Other methods of ozone generation which can be used include photocatalytic reactions, cold plasma, etc.

The relative humidity of the disinfecting atmosphere in the treatment space should be at least 30% and preferably at least 65%, for effective disinfection. To ensure this, one can incorporate a humidifier in the system of the invention, using sterile water from an internal system reservoir to adjust and control the humidity of the issuing gas mixture. In this way, desirable humidity for most effective disinfection is achieved at the point of discharge where dislodgement of a carpet or drapery surface can take place. Since the adjustable humidifier need only increase the humidity of the space to the desirable level, however, it can be placed in any location within the space. In one embodiment, he hydrogen peroxide vapor is applied, in controlled amounts, to the air/water vapor issuing from the humidifier and thus added to the ozone/oxygen containing gas mixture. Alternatively, hydrogen peroxide can be applied to the water used to humidify the target location. Hydrogen peroxide is commercially available as aqueous solutions of standard concentrations of hydrogen peroxide. For use in embodiments of the present invention, a standard solution of known peroxide concentration is suitably diluted down by a fixed volume of distilled water. The peroxide load is standardized based on the known volume of water from the peroxide solution required to raise the relative humidity to the desired extent, e.g. from 40-80%. From this, the amount of hydrogen peroxide in volume % or ppm by volume introduced into the treatment facility can be calculated.

Certain systems according to embodiments of the invention may include a temperature adjuster and controller for the gas mixture. This can be a simple heater/cooler through which either the incident oxygen or the generated oxygen/ozone mixture passes prior to discharge into the room atmosphere. While simple adjustment of the temperature of the room using an external room heating system and thermostat can be effective, it is preferred to adjust the temperature of the issuing gas mixture, for most effective treatment of the carpet and drapery surfaces.

The system of the invention also preferably includes at least one ozone removal unit. Such units are known, and can be purchased commercially for use in the present invention. Depending on the volume of the room atmosphere and the capacity of the ozone removal unit, more than one such unit may be incorporated in the system of the invention. Suitable ozone removal units are those based on activated carbon as the removal medium. These act very quickly, and do not lead to the formation of hazardous reaction products. The inclusion of such units enables the treated facility to be cleared of ozone and returned to normal use rapidly, for economic reasons. Other types include systems based on catalysts such as manganese oxide or other metal oxides, which may be heated to remove moisture, thermal destruction in conjunction with other metals including platinum or palladium.

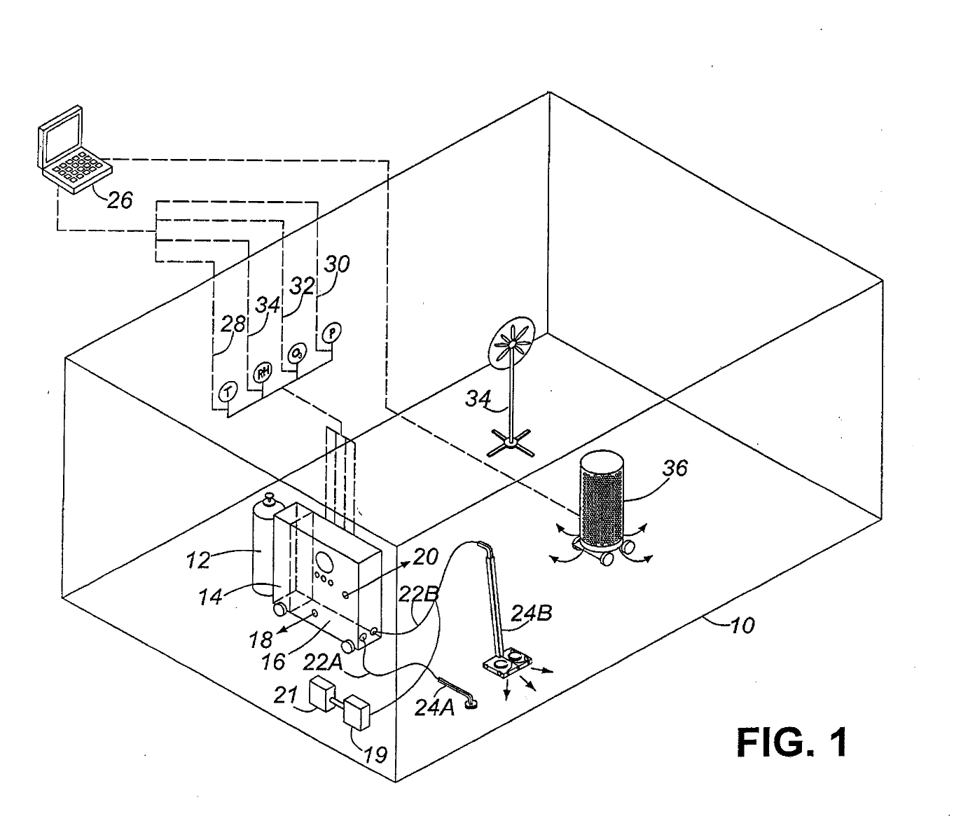

FIG. 1 of the accompanying drawings shows a room 10 suspected of infestation with bed bugs, their eggs and larvae, and closed ready for treatment by a process according to an embodiment of the invention. The room is substantially sealed. Inside the room is a pressurized cylinder 12 of oxygen, feeding oxygen gas into a humidifier 14 and thence to an ozone generator 16, which includes electrical discharge plates of variable voltage to adjust the quantity of ozone which is generated. A heater and a pressure controller (not shown) may be disposed near the entrance to the ozone generator. Output of oxygen/ozone gas mixture is via room outlets 18, 20 to the atmosphere of the room 10, and via wands 22A and/or 22B to a dislodgement means in the form of scrubbing brushes 24A and 24B mounted on the outlet ends of the respective wands 22A, 22B. The heater, the pressure controller, the voltage supplied to the ozone generator 16 and the humidity level supplied by the humidifier 14 are all controlled and adjusted from an external control panel 26 via respective electrical connections 28, 30, 32 and 34. Also disposed within the room is an oscillating fan 34 and an ozone destruct filter unit 36.

Disposed within the room 10 is a container of aqueous hydrogen peroxide solution 19 and associated air blower 21 which, during operation, blows vaporized hydrogen peroxide in controlled amounts into discharge wand 22A and 22B to mix with the output of ozone/oxygen therein. The amount of hydrogen peroxide being supplied is controlled by adjustment of the blower 21 through a connection thereof to the control panel 26. In an alternative arrangement, hydrogen peroxide can be supplied from generator 19 to the humidifier 14.

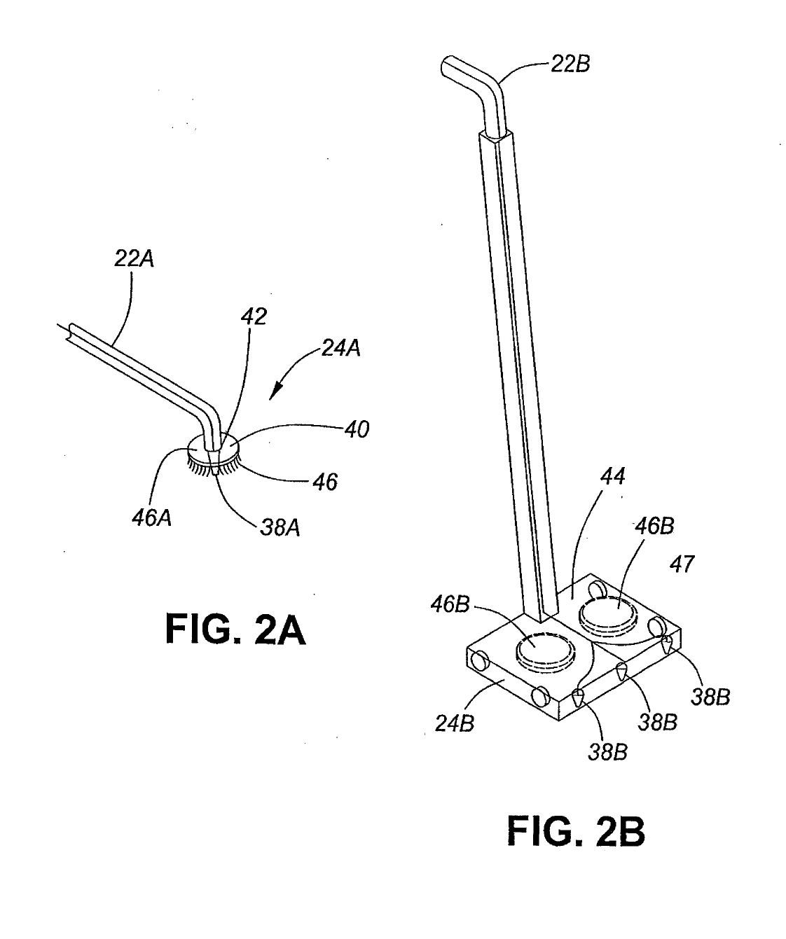

FIGS. 2A and 2B of the accompanying drawings show in more detail forms of dislodgement means 24A and 24B for use in the present invention, attached to the outlet, discharge ends of respective wands 22. The dislodgement means 24A has a jet outlet nozzle 38A at its extremity, and a generally circular plate 40 mounted on the wand 22A near the discharge end. The wand 22A passes through a central aperture 42 in a plate 40. The plate 40 has brush bristles 46A mounted on its lower surface, arranged in two arcs around the jet outlet nozzle 38A and protruding downwardly to an extent just beyond the extent of outlet from nozzle 38A. In use, oxygen/ozone gas mixture or oxygen/ozone/hydrogen peroxide gas mixture issues from nozzle 38A at relatively high pressure, and can be directed by the operator holding the wand to a carpet surface area while at the same time the operator scrubs the carpet surface area with the bristles 46A.

FIG. 2B shows an alternative but essentially similar arrangement, in which plate 40 is replaced by a wheeled platform 44 carrying two rotary brushes 46B and three gas jet outlets 38B for the oxygen/ozone/hydrogen peroxide delivery at pressure, located forwardly of the rotary brushes 46B.

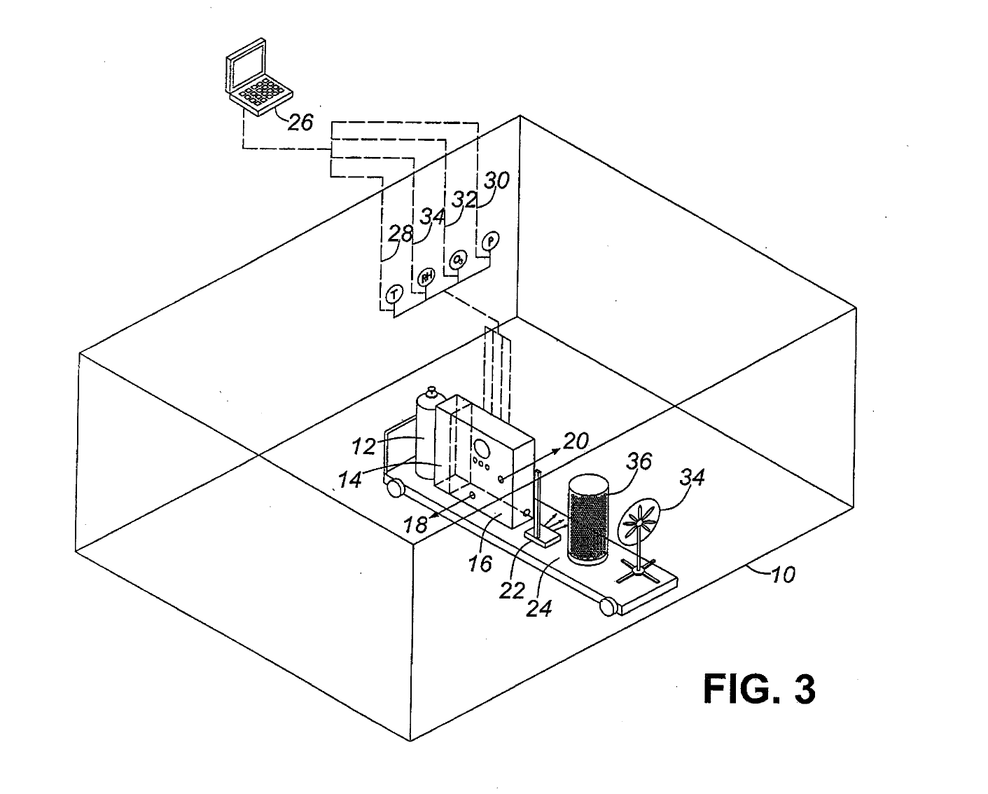

FIG. 3 of the accompanying drawings illustrates the portability of a system according to the invention. Parts are numbered as in FIG. 1. A 4-wheeled cart 48 is provided, on which all the component parts of the system can be loaded for ease of transportation from one room to another. The instrumentation and control panel can be disconnected for transportation, and re-connected and disposed outside when the apparatus is placed in another room for use as shown in FIG. 1. The cart 48 is removed while the system is in use, but is loaded with the components after use, either for transportation to another room or for storage.

The operation of the system will be readily apparent from the preceding description of its component parts and their inter-connection. The cart 48 carrying the component parts is wheeled into the room 10 to be disinfected, and the parts are distributed around the room and connected together as illustrated in FIG. 1. An operator wearing a hazard suit and other appropriate protective clothing enters the room and holds the wand 22. The room is sealed. Conditions of treatment are set on the control panel 26, and the apparatus is switched on so that oxygen/ozone/hydrogen peroxide gas mixture at controlled ozone concentration, hydrogen peroxide concentration, relative humidity, temperature and elevated pressure issues from jet nozzle 38. The operator applies the jetted gas mixture to the carpet surfaces, drapery surfaces and other absorbent surfaces in the room, scrubbing the surfaces at the same time with the bristles 46. The room may become pressurized above atmospheric pressure, due to the introduction of the oxygen/ozone gas mixture. Pressure is continually monitored by the control panel 26 to ensure safe working conditions for the operator, as well as the temperature, humidity and ozone concentration in the room. Smooth surfaces in the room may not need the action of the dislodgement means, but are satisfactorily treated by contact with the disinfecting atmosphere in the room,. The oscillating fan 34 is operated throughout the procedure, to circulate the oxygen/ozone mixture throughout the room.

After a pre-set time of the procedure, and after all the appropriate, absorbent surfaces have been scrubbed, a time not normally exceeding 90 minutes, the hydrogen peroxide supply, the oxygen supply and ozone generator are switched off. Then the ozone destruct filter 36 is operated, sucking in the ozone-containing gases, destroying the ozone and issuing pure oxygen from it. The room can now be opened, the apparatus disconnected and loaded on the cart 48, and the room put back to its normal use.

1. A process of combating bed bugs, eggs or larvae thereof, which comprises:
exposing bed bugs, their eggs or larvae to a disinfecting atmosphere which includes ozone at an amount of 2-350 ppm by weight and hydrogen peroxide at an amount of 0.2-10 wt. %, at a relative humidity of at least 30%, and for a period sufficient for an effective kill thereof.

2. (canceled)

3. The process of claim 1 wherein the amount of ozone in the disinfecting atmosphere is from 20-200 ppm.

4. The process of claim 3 wherein the amount of ozone in the disinfecting atmosphere is from 20-100 ppm.

5. The process of claim 4 wherein the amount of ozone in the disinfecting atmosphere is from 35-90 ppm.

6. (canceled)

7. The process of claim 1, wherein the hydrogen peroxide amount in the disinfecting atmosphere is from 0.5-7%.

8. The process of claim 7, wherein the hydrogen peroxide amount in the disinfecting atmosphere is from 1-5%.

9. The process of claim 1, which is conducted in an enclosed space suspected of bed bug infestation, and wherein:
the period of exposure to the disinfecting atmosphere is at least 3 hours; and
the process further includes a subsequent step of removing ozone from the atmosphere down to 0.04 ppm or less.

10. The process of claim 9 wherein the period of exposure is from about 3 hours to about 48 hours.

11. The process of claim 10 wherein the period of exposure is from about 6 hours to about 48 hours.

12. The process of claim 7 wherein the period of exposure is from about 24 hours to about 48 hours.

13. The process of claim 7 wherein the period of exposure is from about 24 hours to about 36 hours.

14. The process of claim 1, including the additional step of subjecting porous and fibrous surfaces suspected of bed bug infestation to physical agitation while exposed to the disinfecting atmosphere.

15. The process of claim 14, wherein the physical agitation is conducted with application of bristles.

16. The process of claim 14, wherein the physical agitation is conducted with application of pressure jets supplying the disinfecting atmosphere to the surfaces.

17. The process of claim 14, wherein the physical agitation is conducted with application of ultrasonic energy, radio frequency energy or electromagnetic waves, capable of causing physical disruption.

18. A portable system for destroying bed bugs, eggs or larvae thereof, in rooms and on surfaces therein, comprising:
an ozone generator for discharging into the room a gaseous mixture including ozone;
an ozone controller adapted to control the amount of discharged ozone;
a source of hydrogen peroxide for discharging controlled amounts of hydrogen peroxide into the room;
means for discharging the hydrogen peroxide and ozone into the room;
humidity adjusting means adapted to increase or decrease the relative humidity of the room during treatment; and
an ozone remover adapted to destroy ozone, down to a safe level in the room atmosphere for subsequent human utilization.

19. The system of claim 18, wherein the means for discharging the hydrogen peroxide and ozone into the room includes a discharge wand having an outlet end.

20. The system of claim 19, wherein the outlet end includes physical agitation means.

21. The system of claim 20, wherein the physical agitation means is bristles for scrubbing purposes.

22. The system of claim 18, wherein the means for discharging hydrogen peroxide and ozone is an outlet pressure jet for effecting physical agitation of fibrous surfaces to which it is applied.
